(19) United States
(12) Patent Application Publication
(10) Pub. No.: US 2024/0002597 A1
(43) Pub. Date: Jan. 4, 2024

(54) ADDITIVE MANUFACTURING METHOD FOR MAKING A THREE-DIMENSIONAL OBJECT

(71) Applicant: SOLVAY SPECIALTY POLYMERS USA, LLC, Alpharetta (GA)

(72) Inventors: Chantal Louis, Alpharetta, GA (US); Mohammad Jamal El-Hibri, Atlanta, GA (US); Justin Sirrine, Alpharetta, GA (US); Ryan Hammonds, Atlanta, GA (US)

(73) Assignee: SOLVAY SPECIALTY POLYMERS USA, LLC, Alpharetta, GA (US)

(21) Appl. No.: 18/039,467

(22) PCT Filed: Nov. 23, 2021
(86) PCT No.: PCT/EP2021/082569

§ 371 Date: May 30, 2023

Related U.S. Application Data
(60) Provisional application No. 63/119,171, filed on Nov. 30, 2020.

(30) Foreign Application Priority Data
Feb. 8, 2021 (EP) 21155706.1
Nov. 23, 2021 (WO) PCT/EP2021/82569

(51) Int. Cl. C08G 65/40; B29C 64/118

(52) U.S. Cl. CPC C08G 65/40; B29C 64/118; B33Y 70/00

(57) ABSTRACT

The present disclosure relates to an additive manufacturing (AM) method for making a three-dimensional (3D) object, using a part material (M) comprising at least one PEEK-PEoEK copolymer, in particular to a 3D object obtainable by Fused Deposition Modelling (FDM) or Fused Filament Fabrication (FFF) from this part material (M).

### RELATED APPLICATIONS

This application claims priorities of U.S. provisional application 63/119,171 filed on Nov. 30, 2020, and of EP patent application 21155706.1 filed on Feb. 8, 2021, the whole content of each of these applications being incorporated herein by reference for all purposes.

### TECHNICAL FIELD

The present disclosure relates to an additive manufacturing (AM) method for making a three-dimensional (3D) object, using a part material (M) comprising at least one copolymer comprising poly(ether ether ketone) (PEEK) repeat units and poly(ether ortho ether ketone) (PEoEK) repeat units, in particular to a 3D object obtainable by Fused Deposition Modeling (FDM) or Fused Filament Fabrication (FFF) from this part material (M).

### BACKGROUND

Additive manufacturing systems are used to print or otherwise build 3D parts from digital representations of the 3D parts using one or more additive manufacturing techniques. Examples of commercially available additive manufacturing techniques include extrusion-based techniques, selective laser sintering, powder/binder jetting, electron-beam melting and stereolithography processes. For each of these techniques, the digital representation of the 3D part is initially sliced into multiple horizontal layers. For each sliced layer, a tool path is then generated, which provides instructions for the particular additive manufacturing system to print the given layer.

For example, in an extrusion-based additive manufacturing system, a 3D part may be printed from a digital representation of the 3D part in a layer-by-layer manner by extruding and adjoining strips of a part material. The part material is extruded through an extrusion tip carried by a print head of the system, and is deposited as a sequence of roads on a platen in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation. An example of extrusion-based additive manufacturing system starting from filaments is called Fused Filament Fabrication (FFF), also known as Fused Deposition Modelling (FDM). Pellet Additive Manufacturing (PAM) is another example of an extrusion-based 3D printing method capable of printing raw materials in pellet form.

Poly(aryl ether ketone) polymers (PAEK), such as poly(ether ether ketone) polymer (PEEK), are known for their high temperature performance and excellent chemical resistance. Their uses to prepare 3D objects/articles/parts have been described in the literature. For some semi-crystalline polymers, such as PEEK, the processing temperature is too high, causing degradation and/or crosslinking. This is known to negatively affect material processability and recycling by Selective Laser Sintering (SLS), another well-used 3D printing process using polymer powders as part material.

The PEEK printability drawback in extrusion-based 3D printing processes has been addressed in the patent literature in a number of different ways. WO 2019/055737 A1 (Arkema) notably describes a PEKK 70/30 copolymer that crystallizes more slowly than PEEK, enabling facile printing, with a favourable property profile and the option to use a post-printing annealing process that further improves some mechanical properties and chemical resistance. WO 2015/081009 A1 (Stratasys) describes a substantially miscible polymer blend of one semi-crystalline polymer with a second polymer that serves to retard the crystallization speed of the first semi-crystalline polymer.

PEEK-PEDEK copolymers (including PEDEK units of formula: -Ph-Ph-O-Ph-C(O)-Ph-, with -Ph- being a 1,4-phenylene unit, and comprising more than 65% PEEK units of formula -Ph′-O-Ph′-C(O)-Ph′-O—, with -Ph′- being a 1,4-phenylene group) have also been described to prepare shaped articles using melting and extrusion of the feedstock material. WO 2017/051202 A1 (Victrex) describes a PEEK-PEDEK 75/25 copolymer, which offers slower crystallization kinetics than PEEK. While these materials exhibit lower melting temperatures, their mechanical properties are not as good as PEEK.

An object of the present invention is to provide a PAEK-based polymer material to be used in extrusion-based 3D printing processes with lower melting temperatures, slower crystallization speed, and high mechanical and chemical resistance performances. As described below, PEEK-PEoEK copolymers comprising PEEK and PEoEK repeat units offer a suitable technical solution for this purpose.

PEEK-PEoEK copolymers have been described in the art. JP1221426 notably describes PEEK-PEoEK copolymers in its examples 5 and 6, manufactured from hydroquinone, catechol and difluorobenzophenone, as allegedly possessing increased glass transition temperature, and simultaneously excellent heat resistance. Similarly, A. Ben-Haida et at in Macromolecules, 2006, 39, 6467-6472 describes 50/50 and 70/30 copolymers of PEEK and PEoEK manufactured by step-growth polycondensation of hydroquinone and catechol with 4,4′-difluorobenzophenone in diphenyl sulfone. These documents however do not describe PEEK-PEoEK filaments or pellets for use in extrusion-based 3D manufacturing.

### DISCLOSURE OF THE INVENTION

The present invention relates to a method for manufacturing a 3D object using an additive manufacturing system, such as an extrusion-based additive manufacturing system (for example FFF or FDM).

The 3D objects or articles obtainable by such method of manufacture can be used in a variety of final applications. Mention can be made in particular of implantable devices, medical devices, dental prostheses, brackets and complex shaped parts in the aerospace industry and under-the-hood parts in the automotive industry.

The method of the present invention comprises a step of printing layers of the 3D object from a part material (M). The part material (M) may be in the form of filaments and be used in extrusion-based additive manufacturing system starting from filaments, called Fused Filament Fabrication (FFF), also known as Fused Deposition Modelling (FDM). The part material may also be in the form of pellets and be used in a 3D printing technology capable of printing raw materials in pellet form (PAM).

The present invention generally relates to an AM method for making a 3D object, comprising extruding a part material (M) comprising a polymer component, such polymer component comprising at least one PEEK-PEoEK copolymer, wherein the copolymer comprises at least 50 mol. %, collectively, of repeat units (R_{PEEK}) and repeat units (R_{PEoEK}), relative to the total number of repeat units in the PEEK-PEoEK copolymer, wherein:
(a) repeat units (R_{PEEK}) are repeat units of formula (A):

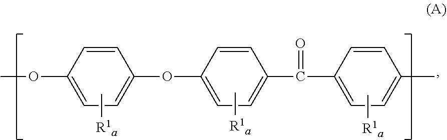

and
(b) repeat units (R_{PEoEK}) are repeat units of formula (B):

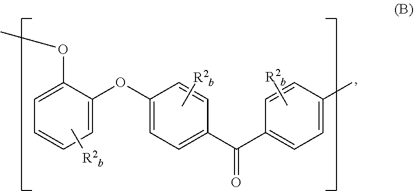

wherein
each R¹ and R², equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b, equal to or different from each other, is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

The merit of the applicant has been to surprisingly identify that the PEEK-PEoEK copolymer, alone or blended with other polymers (e.g. PEEK), possess both a slow crystallization rate and a percent crystallinity which is lower than neat PEEK. These properties notably enable a more reliable printing of objects as compared to neat PEEK due to the reduced crystallinity, as well as its use for 3D printing larger and complex objects. Interestingly, crystallization speed is not so slow that crystallinity is completely eliminated from the 3D printed objects. 3D printed parts from these compositions still possess some crystallinity after printing, and unexpectedly, parts printed from these compositions possess little to no warpage when printed with a heated chamber temperature close to the glass transition temperature of the polymer (Tg).

The expression “polymer” or “copolymer” is hereby used to designate homopolymers containing substantially 100 mol. % of the same recurring units and copolymers comprising at least 50 mol. % of the same recurring units, for example at least about 60 mol. %, at least about 65 mol. %, at least about 70 mol. %, at least about 75 mol. %, at least about 80 mol. %, at least about 85 mol. %, at least about 90 mol. %, at least about 95 mol. % or at least about 98 mol. %.

The expression “part material” hereby refers to a blend of material, notably polymeric compounds, intended to form a 3D object or a part of the 3D object. The part material (M) is according to the present invention used as feedstocks to be used for the manufacture of 3D objects or part of 3D objects.

The method of the present invention employs a PEEK-PEoEK copolymer as main element of the part material, which can for example be shaped in the form of filaments to build a 3D object (e.g. a 3D model, a 3D article or a 3D part). The polymers may also be printed in the form of pellets, for example pellets of polymer blends.

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

According to an embodiment, the part material is in the form of a filament. The expression “filament” refers to a thread-like object or fiber or strand formed of a material or blend of materials which, according to the present invention, comprises at least the PEEK-PEoEK copolymer described herein.

The filament may have a cylindrical or substantially cylindrical geometry, or may have a non-cylindrical geometry, such as a ribbon filament geometry; further, filament may have a hollow geometry, or may have a core-shell geometry, with another polymeric composition, being used to form either the core or the shell.

According to an embodiment of the invention, the method for manufacturing a 3D object with an AM system comprises a step consisting in extruding the part material (M). This step may, for example, occur when printing or depositing strips or layers of part material (M). The method for manufacturing 3D objects with an extrusion-based additive manufacturing system is also known as Fused Filament Fabrication technique (FFF), Fused Deposition Modeling (FDM), as well as Pellet Additive Manufacturing technique (PAM).

FFF/FDM 3D printers are, for example, commercially available from Apium, from Roboze, from Hyrel or from Stratasys, Inc. (under the trade name Fortus®). SLS 3D printers are, for example, available from EOS Corporation under the trade name EOSINT® P. FRTP 3D printers are, for example, available from Markforged.

PAM 3D printers are, for example, commercially available from Pollen. BAAM (Big Area Additive Manufacturing) is an industrial sized, additive machine commercially available from Cincinnati Inc.

Part Material

The part material (M) employed in the method of the present invention comprises a polymeric component, such polymer component comprising at least one PEEK-PEoEK copolymer, wherein the copolymer comprises at least 50 mol. %, collectively, of repeat units (R_{PEEK}) and repeat units (R_{PEoEK}), relative to the total number of repeat units in the PEEK-PEoEK copolymer, wherein:
(a) repeat units (R_{PEEK}) are repeat units of formula (A):

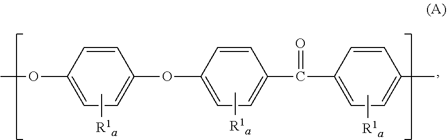

and
(b) repeat units (R_{PEoEK}) are repeat units of formula (B):

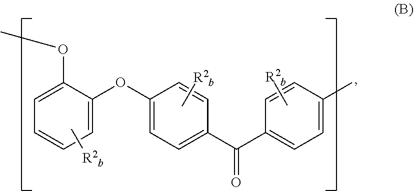

wherein
each R¹ and R², equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b, equal to or different from each other, is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

The applicant has found that part material (M) based on PEEK-PEoEK copolymer, possibly blended with other polymers (e.g. PEEK), possess a slow crystallization rate, which enables 3D printing of large and complex objects/articles. 3D printed parts from the part materials comprising PEEK-PEoEK copolymer possibly blended with other polymers (e.g. PEEK) possess some crystallinity after printing, but little to no warpage when printed with a heated chamber temperature close to Tg.

The part material (M) of the invention may include other components. For example, the part material may comprise at least one additive, notably at least one additive selected from the group consisting of fillers, colorants, lubricants, plasticizers, stabilizers, flame retardants, nucleating agents, flow enhancers and combinations thereof. Fillers in this context can be reinforcing or non-reinforcing in nature. For example, the part material may comprise from 0.1 wt. % to 60 wt. % of at least one additive, with respect to the total weight of the part material (M). For example, the amount of additives in the material (M) may range from 0.5 wt. % to 50 wt. %, from 1 wt. % to 40 wt. %, from 5 wt. % to 30 wt. % or from 10 wt. % to 20 wt. %, with respect to the total weight of the material (M).

In embodiments that include fillers, the concentration of the fillers in the part material (M) ranges from 0.1 wt. % to 60 wt. %, with respect to the total weight of the part material (M). Suitable fillers include calcium carbonate, magnesium carbonate, glass fibers, graphite, carbon black, carbon fibers, carbon nanofibers, graphene, graphene oxide, fullerenes, talc, wollastonite, mica, alumina, silica, titanium dioxide, kaolin, silicon carbide, zirconium tungstate, boron nitride and combinations thereof. For example, the amount of fillers in the material (M) may range from 0.5 wt. % to 50 wt. %, from 1 wt. % to 40 wt. %, from 5 wt. % to 30 wt. % or from 10 wt. % to 20 wt. %, with respect to the total weight of the material (M).

According to a first embodiment, the part material (M) of the present invention comprises a polymeric component comprising from 20 to 100 wt. %, from 30 to 99 wt. %, from 40 to 95 wt. % or from 50 to 90 wt. % of at least one PEEK-PEoEK copolymer, based on the total weight of the polymeric component.

The polymeric component of the part material (M) may comprise another polymer than the PEEK-PEoEK described herein. It may for example comprise a poly(aryl ether ketone) (PAEK) distinct from such PEEK-PEoEK. As used herein, a PAEK denotes any polymer comprising more than 50 mol. % of recurring units (R_{PAEK}) comprising a Ar′—C(═O)—Ar* group, where Ar′ and Ar*, equal to or different from each other, are aromatic groups. Advantageously, said PEAK polymer is a poly(ether ether ketone) (PEEK) homopolymer or copolymer (thereafter PEEK (co)polymer).

According to second embodiment, the part material (M) of the present invention comprises a polymeric component comprising:
from 20 to 99 wt. %, from 30 to 98 wt. %, from 40 to 95 wt. % or from 50 to 90 wt. % of at least one PEEK-PEoEK copolymer,
from 1 to 80 wt. %, from 2 to 70 wt. %, from 5 to 60 wt. % or from 10 to 50 wt. % of at least one PEEK (co)polymer, based on the total weight of the polymeric component.

According to the third embodiment, the part material (M) of the present invention comprises or consists in:
from 20 to 99 wt. %, from 30 to 98 wt. %, from 40 to 95 wt. % or from 50 to 90 wt. % of at least one PEEK-PEoEK copolymer,
from 1 to 80 wt. %, from 2 to 70 wt. %, from 5 to 60 wt. % or from 10 to 50 wt. % of at least one PEEK (co)polymer,
optionally up to 60 wt. %, at least one additive selected from the group consisting of fillers, colorants, lubricants, plasticizers, stabilizers, flame retardants, nucleating agents, flow enhancers and combinations thereof, based on the total weight of the part material (M).

In some embodiments, the polymer component of the part material (M) comprises at least 80 wt. % of the PEEK-PEoEK copolymer, based on the total weight of polymeric component of the part material (M). For example, the polymer component comprises at least 85 wt. % of the PEEK-PEoEK copolymer, at least 90 wt. %, at least 95 wt. %, at least 96 wt. %, at least 97 wt. %, at least 98 wt. % or at least at least 99 wt. % of the PEEK-PEoEK copolymer, based on the polymeric component of the part material (M).

In some embodiments, the polymer component of the part material (M) consists in the PEEK-PEoEK copolymer.

In some embodiments, the part material (M) comprises at least 80 wt. % of the PEEK-PEoEK copolymer, based on the total weight of part material (M). For example, the part material (M) comprises at least 85 wt. % of the PEEK-PEoEK copolymer, at least 90 wt. %, at least 95 wt. %, at least 96 wt. %, at least 97 wt. %, at least 98 wt. % or at least at least 99 wt. % of the PEEK-PEoEK copolymer based on the total weight of the part material (M).

In some embodiments, the part material (M) consists or consists essentially in the PEEK-PEoEK copolymer. As used herein, the expression “consists essentially essentially in the PEEK-PEoEK copolymer” means that the part material (M) may comprise other components in amount of at most 2 wt. %, at most 1 wt. % or at most 0.5 wt. %, relative to the total weight of the part material (M), and so as not to substantially alter the advantageous properties of this material.

PEEK-PEoEK copolymer

As used herein, a “PEEK-PEoEK copolymer” comprises at least 50 mol. %, collectively, of repeat units (R_{PEEK}) and repeat units (R_{PEoEK}), relative to the total number of moles of repeat units in the PEEK-PEoEK copolymer. In some embodiments, the PEEK-PEoEK copolymer comprises at least 51 mol. %, at least 55 mol. %, at least 60 mol. %, at least 70 mol. %, at least 80 mol. %, at least 90 mol. %, at least 95 mol. %, and most preferably at least 99 mol. % of repeat units (R_{PEEK}) and (R_{PEoEK}), relative to the total number of moles of repeat units in the PEEK-PEoEK copolymer.

Repeat unit (R_{PEEK}) is represented by formula (A):

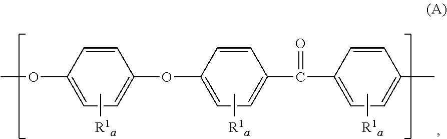

and repeat unit (R_{PEoEK}) is represented by formula (B):

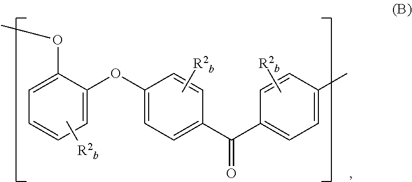

each R1 and R2, equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b, equal to or different from each other, is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

In some preferred embodiments, each a is zero, such that the repeat units (R_{PEEK}) are repeat units of formula (A-1):

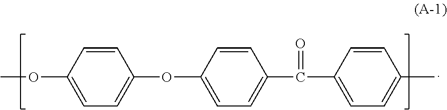

In some preferred embodiments, each b is zero, such that the repeat units (R_{PEoEK}) are repeat units of formula (B-1):

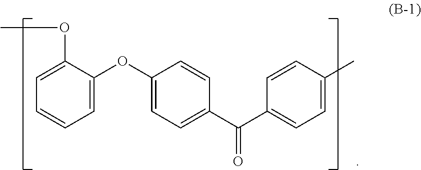

Preferably, repeat units (R_{PEEK}) are repeat units of formula (A-1), and repeat units (R_{PEoEK}) are repeat units of formula (B-1).

The PEEK-PEoEK copolymer of the present invention may additionally comprise repeat units (R_{PAEK}) different from repeat units (R_{PEEK}) and (R_{PEoEK}), as above detailed. In such case, the amount of repeat units (R_{PAEK}) may be comprised between 0.1 and less than 50 mol. %, preferably less than 10 mol. %, more preferably less than 5 mol. %, most preferably less than 2 mol. %, with respect to the total number of moles of repeat units of PEEK-PEoEK copolymer.

When repeat units (R_{PAEK}) different from repeat units (R_{PEEK}) and (R_{PEoEK}) are present in the PEEK-PEoEK copolymer of the present invention, these repeat units (R_{PAEK}) different from units (R_{PEEK}) and (R_{PEoEK}), as described above, generally comply with any of the following formulae (K-A) to (K-M) herein below:

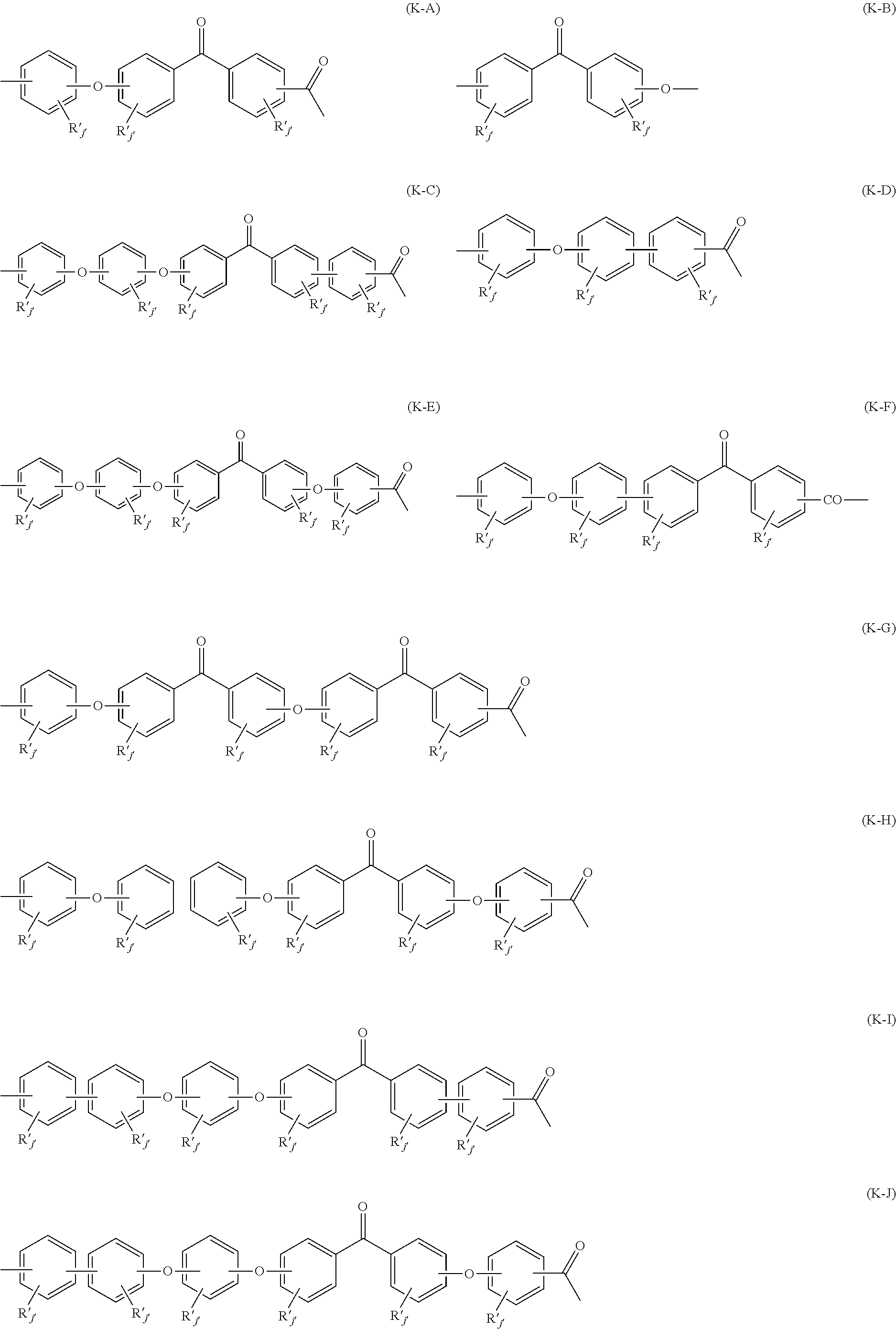

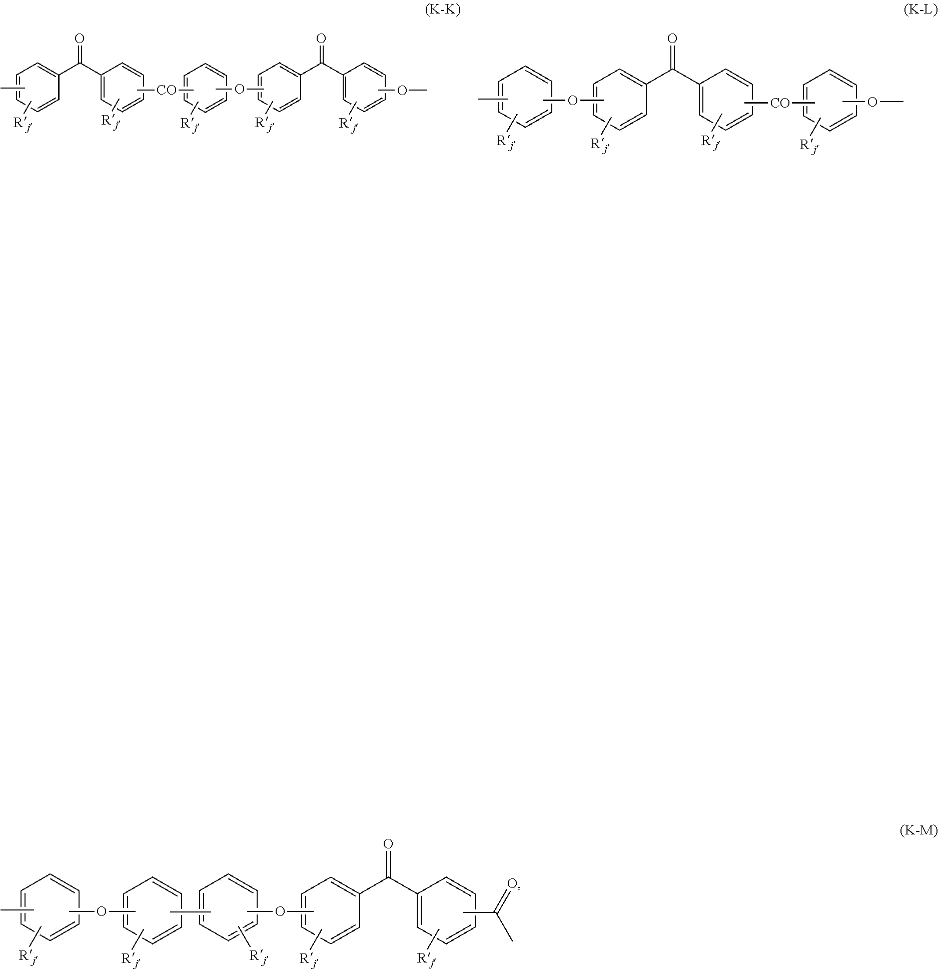

wherein in formula (K-A) to (K-M) above, each of R′, equal to or different from each other, is independently selected at each occurrence from a C₁-C₁₂ group optionally comprising one or more than one heteroatoms; sulfonic acid and sulfonate groups; phosphonic acid and phosphonate groups; amine and quaternary ammonium groups; and each of j′, equal to or different from each other, is independently selected at each occurrence from 0 and an integer of 1 to 4, preferably j′ being equal to zero.

It is nevertheless generally preferred for the PEEK-PEoEK copolymer of the present invention to be essentially composed of repeat units (R_{PEEK}) and (R_{PEoEK}), as above detailed. Thus, in some preferred embodiments, the PEEK-PEoEK copolymer consists essentially of repeat units R_{PEEK} and R_{PEoEK}. As used herein, the expression “consists essentially of repeat units R_{PEEK} and R_{PEoEK}” means that any additional repeat unit different from repeat units R_{PEEK} and R_{PEoEK}, as above detailed, may be present in the PEEK-PEoEK copolymer in amount of at most 2 mol. %, at most 1 mol. % or at most 0.5 mol. %, relative to the total number of moles of repeat units in the PEEK-PEoEK copolymer, and so as not to substantially alter the advantageous properties of the PEEK-PEoEK copolymer.

Repeat units R_{PEEK} and R_{PEoEK} are present in the PEEK-PEoEK copolymer in a R_{PEEK}/R_{PEoEK} molar ratio ranging from 95/5 to 5/95. Preferably, the PEEK-PEoEK copolymers suitable for the powder of the invention are those comprising a majority of R_{PEEK} units, that-is-to-say copolymers in which the R_{PEEK}/R_{PEoEK} molar ratio ranges from 95/5 to more than 50/50, even more preferably from 95/5 to 60/40, still more preferably from 90/10 to 65/35, most preferably 85/15 to 70/30.

In some embodiments, the PEEK-PEoEK copolymer has a melting temperature (Tm) of less than or equal to 340° C., preferably less than or equal to 335° C. The melting temperatures described herein are measured as the peak temperature of the melting endotherm on the second heat scan in a differential scanning calorimeter (DSC) according to ASTM D3418-03 and E794-06, and using heating and cooling rates of 20° C./min.

In some embodiments, the PEEK-PEoEK copolymer has a glass transition temperature (Tg) of at least 135° C. and at most 155° C., preferably at least 140° C., as determined on the 2^{nd} heat scan according to ASTM D3418-03, E1356-03, E793-06, E794-06.

In some embodiments, the PEEK-PEoEK copolymer has as heat of fusion (ΔH) of at least 1 J/g, preferably at least 2 J/g, at least 5 J/g. The heats of fusion described herein are determined as the area under the melting endotherm on the second heat scan in a differential scanning calorimeter (DSC) according to ASTM D3418-03 and E793-06, with heating and cooling rates of 20° C./min. In some aspects, the PEEK-PEoEK copolymer may have a heat of fusion (ΔH) of at most 65 J/g, preferably at most 60 J/g.

According to certain embodiments, the PEEK-PEoEK copolymer possesses a microstructure such that its FT-IR spectrum, when recorded between 600 and 1,000 cm⁻¹ in ATR mode on polymer powder, is such that the following inequalities are satisfied:
(i)

$$\frac{{A}_{700 {cm}^{- 1}}}{{A}_{704 {cm}^{- 1}}} \leq 0.99 ,$$

wherein A_{700 cm}_{^{−1}} is the absorbance at 700 cm⁻¹ and A_{704 cm}_{^{−1}} is the absorbance at 704 cm⁻¹;
(ii)

$$\frac{{A}_{816 {cm}^{- 1}}}{{A}_{835 {cm}^{- 1}}} \geq 0.61 ,$$

wherein A_{816 cm}_{^{−1}} is the of absorbance at 816 cm⁻¹ and A_{835 cm}_{^{−1}} is the absorbance at 835 cm⁻¹;
(iii)

$$\frac{{A}_{623 {cm}^{- 1}}}{{A}_{557 {cm}^{- 1}}} \leq 1.6 ,$$

wherein A_{623 cm}_{^{−1}} is the of absorbance at 623 cm⁻¹ and A_{557 cm}_{^{−1}} is the absorbance at 557 cm⁻¹;
(iv)

$$\frac{{A}_{928 {cm}^{- 1}}}{{A}_{924 cm - 1}} \leq 1.09 ,$$

wherein A_{928 cm}_{^{−1}} is the of absorbance at 928 cm⁻¹ and A_{924 cm}_{^{−1}} is the absorbance at 924 cm⁻¹.

The PEEK-PEoEK copolymer may be such that it has a calcium content of less than 5 ppm, as measured by Inductively Coupled Plasma Optical Emission Spectrometry (ICP-OES) calibrated with standards of known calcium content. Such a particularly low and controlled Ca content is particularly beneficial when the said PEEK-PEoEK copolymer is to be used in metal junctions requiring very stringent dielectric performances. According to these preferred embodiments, the PEEK-PEoEK copolymer may have a calcium content of less than 4 ppm, less than 3 ppm or even more preferably less than 2.5 ppm.

In these preferred embodiments, the PEEK-PEoEK copolymer may also be such that it has a sodium content of less than 1,000 ppm, as measured by Inductively Coupled Plasma Optical Emission Spectrometry (ICP-OES) calibrated with standards of known sodium content. Preferably, the PEEK-PEoEK copolymer may have a sodium content of less than 900 ppm, less than 800 ppm or even more preferably less than 500 ppm.

In some embodiments, the PEEK-PEoEK copolymer may be such that it has a phosphorus content of at least 6 ppm, as measured by Inductively Coupled Plasma Optical Emission Spectrometry (ICP-OES) calibrated with standards of known phosphorus content. Preferably, the PEEK-PEoEK copolymer has a phosphorous content of at least 10 ppm, at least 15 ppm or even more preferably at least 20 ppm.

In the powder of the present invention, it may be advantageous to select PEEK-PEoEK copolymers having increased thermal stability, which may be particularly beneficial in certain fields of use, for example to prepare a 3D object by additive manufacturing. The PEEK-PEoEK copolymers may notably have peak degradation temperatures of at least 550° C., as measured TGA according to ASTM D3850, more preferably at least 551° C. and even more preferably at least 552° C.

Methods adapted for making PEEK-PEoEK copolymers are generally known in the art. They are notably described in co-pending patent applications EP2020/065154 and EP2020/066177 (not published yet).

PAEK Copolymer

As used herein, a poly(aryl ether ketone) (PAEK) denotes any polymer comprising more than 50 mol. % of recurring units (R_{PAEK}) comprising a Ar′—C(═O)—Ar* group, where Ar′ and Ar*, equal to or different from each other, are aromatic groups.

The recurring units (R_{PAEK}) may be selected from the group consisting of units of formulae (J-A) to (J-D) below:

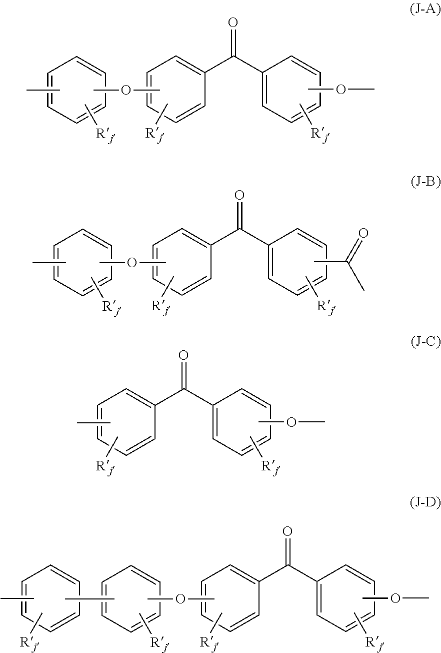

where each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and j′ is zero or an integer ranging from 1 to 4.

In recurring unit (R PAEK), the respective phenylene moieties may independently have 1,2-, 1,4- or 1,3-linkages to the other moieties different from R′ in the recurring unit (R_{PAEK}). Preferably, the phenylene moieties have 1,3- or 1,4-linkages, more preferably they have a 1,4-linkage.

In recurring units (R_{PAEK}), j′ is preferably at each occurrence zero so that the phenylene moieties have no other substituents than those linking the main chain of the polymer.

In some embodiments, the PAEK is poly(ether ether ketone) (PEEK). As used herein, a poly(ether ether ketone) (PEEK) denotes any polymer comprising more than 50 mol. % of recurring units (R_{PAEK}) of formula (J′-A):

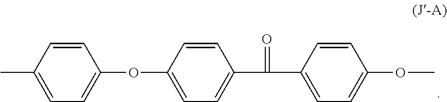

Preferably at least 60 mol. %, 70 mol. %, 80 mol. %, 90 mol. %, 95 mol. %, 99 mol. %, and most preferably all of recurring units (R_{PAEK}) are recurring units (J′-A).

Method for Making a Three-Dimensional (3D) Object

The additive manufacturing (AM) method for making a three-dimensional (3D) object of the present invention comprises a step consisting in extruding the part material (M).

The method of the invention usually takes place using an additive manufacturing system, or a printer, also called a 3D printer.

The method of the invention may also comprise at least one of the following steps, in connection with the 3D printer:
feeding the part material (M) to a discharge head member having a throughbore ending with a discharge tip and a circumferential heater to melt the material (M) in the throughbore;
heating the part material (M) to a temperature of at least 350° C., prior to extrusion;
compressing the part material (M) with a piston, for example with the unmelted filament acting as a piston, in the throughbore;
ensuring relative movement in X- and Y-directions of the discharge tip and of a receiving platform while discharging part material (M) on the receiving platform to form the cross sectional shape;
ensuring relative movement in the Z-direction of the discharge tip and the receiving platform while discharging part material (M) on the receiving platform to form the 3D object or part in elevation.

The 3D object/article/part may be built on substrate, for example a horizontal substrate and/or on a planar substrate. The substrate may be moveable in all directions, for example in the horizontal or vertical direction. During the 3D printing process, the substrate can, for example, be lowered, in order for the part material to be extruded on top of the former layer of polymeric material.

According to an embodiment, the process further comprises a step consisting in producing a support structure. According to this embodiment, the 3D object/article/part is built upon the support structure and both the support structure and the 3D object/article/part are produced using the same AM method. The support structure may be useful in multiple situations. For example, the support structure may be useful in providing sufficient support to the printed or under-printing, 3D object/article/part, in order to avoid distortion of the shape 3D object/article/part, especially when this 3D object/article/part is not planar. This is particularly true when the temperature used to maintain the printed or under-printing, 3D object/article/part is below the re-solidification temperature of the powder.

While not strictly necessary, the 3D object/article/part may also be subjected to heat-treatment after manufacture (also called annealing or tempering). In this case, the 3D object/article/part may be placed in an oven set up at a temperature ranging from 170 to 260° C., preferably from 180 to 220° C., for a period of time of ranging from about 30 minutes to 24 hours, preferably from 1 hour to 8 hours.

The 3D object of the present invention preferably presents a level of crystallinity corresponding to a enthalpy of fusion or heat of fusion of at least 30 J/g, as measured prior to any annealing heat treatment on a second heat scan in a differential scanning calorimeter (DSC) according to ASTM D3418, using a heating rate of 20° C./min and calculated as the difference between the absolute value of the melting endotherm area minus the absolute value of any crystallization endotherm that may be detected during the first heat up scan. In some embodiments, the heat of fusion of the 3D object as printed prior to any heat treatment and as measured according to the above description is at least 32 J/g, at least 33 J/g or at least 34 J/g.

The 3D object of the present invention preferably presents a Z-direction tensile stress at yield or break greater than about 50% of the x-y direction tensile stress at yield or break, preferably at least 55%, even more preferably 60%.

Part Material (M)

The part material (M) of the present invention can be made by methods well known to the person of ordinary skill in the art. For example, such methods include, but are not limited to, melt-mixing processes. Melt-mixing processes are typically carried out by heating the polymer components above the melting temperature of the thermoplastic polymers thereby forming a melt of the thermoplastic polymers. In some embodiments, the processing temperature ranges from about 280-450° C., preferably from about 290-440° C., from about 300-430° C. or from about 310-420° C. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the part material, the components of the part material, e.g. PEEK-PEoEK polymer, optional other polymers, such as PEEK polymer, optionally additives, are fed to the melt-mixing apparatus and melt-mixed in that apparatus. The components may be fed simultaneously as a powder mixture or granule mixer, also known as dry-blend, or may be fed separately.

The order of combining the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

The part material may for example be used in the form of pellets in Pellet Additive Manufacturing (PAM) 3D printing processes.

When the part material is in the form of pellets, the pellets may have a size ranging from 1 mm to 1 cm, for example from 2 mm to 5 mm or from 2.5 mm to 4.5 mm.

Filament Material

The present invention also relates to a filament material (F) comprising a polymer component comprising at least one PEEK-PEoEK copolymer, as above-described.

According to this aspect of the invention, the PEEK-PEoEK copolymer is as described above.

According to an embodiment, the filament material further comprises one or several other polymers, for example at least one PEEK polymer.

This filament material is well-suited for use in a method for manufacturing a three-dimensional object.

The filament may have a cylindrical or substantially cylindrical geometry, or may have a non-cylindrical geometry, such as a ribbon filament geometry; further, filament may have a hollow geometry, or may have a core-shell geometry, with the support material of the present invention being used to form either the core or the shell.

When the filament has a cylindrical geometry, its diameter may vary between 0.5 mm and 5 mm, for example between 0.8 and 4 mm or for example between 1 mm and 3.5 mm. The diameter of the filament can be chosen to feed a specific FFF 3D printer. An example of filament diameter used extensively in FFF process is 1.75 mm or 2.85 mm diameter. The accuracy of the filament diameter is +/−200 microns, for example +/−100 microns or +/−50 microns.

The filament of the present invention can be prepared from a two-step process in which a compound is first produced to make part material in pellet form, and then the pellets are extruded to produce the filament. Alternatively, the filament of the present invention can be prepared from an integrated process in which the compounds and the filaments are prepared in a one-step process.

The filament of the present invention can be made from the part material by methods including, but not limited to, melt-mixing processes. Melt-mixing processes are typically carried out by heating the polymer components above the highest melting temperature and glass transition temperature of the thermoplastic polymers thereby forming a melt of the thermoplastic polymers. In some embodiments, the processing temperature ranges from about 280-450° C., preferably from about 290-440° C., from about 300-430° C. or from about 310-420° C.

The process for the preparation of the filament can be carried out in a melt-mixing apparatus, for which any melt-mixing apparatus known to the one skilled in the art of preparing polymer compositions by melt mixing can be used. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the filament, the components of the part material are fed to the melt-mixing apparatus and melt-mixed in that apparatus. The components may be fed simultaneously as a powder mixture or granule mixer, also known as dry-blend, or may be fed separately.

The order of combining the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

The method for manufacturing the filaments also comprises a step of extrusion, for example with a die. For this purpose, any standard molding technique can be used; standard techniques including shaping the polymer compositions in a molten/softened form can be advantageously applied, and include notably compression molding, extrusion molding, injection molding, transfer molding and the like. Extrusion molding is preferred. Dies may be used to shape the articles, for example a die having a circular orifice if the article is a filament of cylindrical geometry.

In some embodiments, the filament is obtained by a melt-mixing process carried out by heating the polymer component above its melting temperature and melt-mixing the components of the part material.

The method may comprise if needed several successive steps of melt-mixing or extrusion under different conditions.

The process itself, or each step of the process if relevant, may also comprise a step consisting in a cooling of the molten mixture.

Support Material

The method of the present invention may also employ another polymeric component to support the 3D object under construction. This polymeric component, similar or distinct from the part material used to build a 3D object, is hereby called support material. A support material may be required during 3D printing to provide vertical and/or lateral support to the part material under construction. The support material will need to have similar thermal properties to the part material, to the extent it can stay solid and rigid to provide the needed support to the part material in hollow or overhang regions of the part.

The support material, possibly used in the context of the present method, advantageously possesses a high melting temperature (i.e. above 260° C.), in order to resist high temperature applications. The support material may also possess a water absorption behaviour or a solubility in water at a temperature lower than 110° C., in order sufficiently swell or deform upon exposure to moisture.

According to an embodiment of the present invention, the method for manufacturing a three-dimensional object with an additive manufacturing system further comprises the steps of:
printing layers of a support structure from the support material, and
removing at least a portion of the support structure from the three-dimensional object.

A variety of polymeric components can be used as a support material. Notably, support material can comprise polyamides or copolyamides, such as for example the ones described in PCT applications WO 2017/167691 and WO 2017/167692.

Applications

The present invention also relates to the use of a part material (M) comprising a polymeric component as above-described for the manufacture of three-dimensional objects.

The present invention also relates to the use of a filament material comprising a polymeric component as above-described for the manufacture of three-dimensional objects.

All of the embodiments described above with respect to the part material do apply equally to the use of the part material or the use of the filament material.

The present invention also relates to the use of a part material (M) comprising a polymeric component as above-described for the manufacture of a filament for use in the manufacture of three-dimensional objects.

The present invention also relates to 3D objects or 3D articles obtainable, at least in part, from the method of manufacture of the present invention, using the part material herein described. These 3D objects or 3D articles preferably present a density comparable to injection molded objects or articles. They also present comparable or improved mechanical properties.

The 3D objects or articles obtainable by such method of manufacture can be used in a variety of final applications. Mention can be made in particular of implantable device, dental prostheses, brackets and complex shaped parts in the aerospace industry, under-the-hood parts in the automotive industry, oil and gas applications and as electronic components.

The 3D objects or articles obtainable by such method of manufacture can be used in many aircraft applications including, for example, passenger service units, staircases, window reveals, ceiling panels, information displays, window covers, ceiling panels, sidewall panels, wall partitions, display cases, mirrors, sun visors, window shades, storage bins, storage doors, ceiling overhead storage lockers, serving trays, seat backs, cabin partitions, and ducts.

The 3D objects or articles obtainable by such method of manufacture can be used in many automotive applications including, for example, connectors, fittings, emission control systems and injection molding components.

The 3D objects or articles obtainable by such method of manufacture can be used in oil and gas applications, such as off-shore solutions to protect against corrosion, chemical attacks, and aging

The 3D objects or articles obtainable by such method of manufacture can be used as electronic components including, for example, wire & cable applications requiring high excellent heat and chemical resistance, as well as good flame, smoke, and toxicity properties, and parts requiring dimensional stability.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

Starting Materials

Hydroquinone, photo grade, was procured from Eastman, USA. It contained 0.38 wt % moisture, which amount was used to adapt the charge weights. All weights indicated include moisture.

Resorcinol, ACS reagent grade, was procured from Aldrich, USA 4,4′-Biphenol, polymer grade, was procured from SI, USA.

Pyrocatechol, flakes, was procured from Solvay USA. Its purity was 99.85% by GC. It contained 680 ppm moisture, which amount was used to adapt the charge weights. All weights indicated include moisture. 4,4′-Difluorobenzophenone, polymer grade (99.8%+), was procured from Malwa, India

Diphenyl sulfone (polymer grade) was procured from Proviron (99.8% pure).

Sodium carbonate, light soda ash, was procured from Solvay S.A., France.

Potassium carbonate with a d90<45 μm was procured from Armand products.

Lithium chloride (anhydrous grade) was procured from Acros.

### Preparation of Resins

PEEK

In a 500 mL 4-neck reaction flask fitted with a stirrer, a N2 inlet tube, a Claisen adapter with a thermocouple plunging in the reaction medium, and a Dean-Stark trap with a condenser and a dry ice trap were introduced 127.82 g of diphenyl sulfone, 28.685 g of hydroquinone and 57.326 g of 4,4′-difluorobenzophenone.

The flask content was evacuated under vacuum and then filled with high purity nitrogen (containing less than 10 ppm O2). The reaction mixture was then placed under a constant nitrogen purge (60 mL/min).

The reaction mixture was heated slowly to 150° C. At 150° C., a mixture of 28.481 g of Na₂CO₃ and 0.180 g of K₂CO₃ was added via a powder dispenser to the reaction mixture over 30 minutes. At the end of the addition, the reaction mixture was heated to 320° C. at 1° C./minute. After 14 minutes at 320° C., the reaction was terminated in 3 stages: 6.818 g of 4,4′-difluorobenzophenone were added to the reaction mixture while keeping a nitrogen purge on the reactor. After 5 minutes, 0.444 g of lithium chloride were added to the reaction mixture. 10 minutes later, another 2.273 g of 4,4′-difluorobenzophenone were added to the reactor and the reaction mixture was kept at temperature for 15 minutes.

The reactor content was then poured from the reactor into a SS pan and cooled.

The solid was broken up and ground in an attrition mill through a 2 mm screen. Diphenyl sulfone and salts were extracted from the mixture with acetone and water.

The powder was then dried at 120° C. under vacuum for 12 hours yielding 65 g of a white powder.

The melt viscosity measured by capillary rheology at 400° C., 1000 s−1 was 0.30 kN-s/m2

PEEK-PEoEK copolymer 80/20

In a 1000 mL 4-neck reaction flask fitted with a stirrer, a N2 inlet tube, a Claisen adapter with a thermocouple plunging in the reaction medium, and a Dean-Stark trap with a condenser and a dry ice trap were introduced 343.63 g of diphenyl sulfone, 61.852 g of hydroquinone, 15.426 g of pyrocatechol and 153.809 g of 4,4′-difluorobenzophenone. The flask content was evacuated under vacuum and then filled with high purity nitrogen (containing less than 10 ppm O2). The reaction mixture was then placed under a constant nitrogen purge (60 mL/min).

The reaction mixture was heated slowly to 150° C. At 150° C., a mixture of 76.938 g of Na2CO3 and 0.484 g of K2CO3 was added via a powder dispenser to the reaction mixture over 30 minutes. At the end of the addition, the reaction mixture was heated to 320° C. at 1° C./minute. After 25 minutes at 320° C., the reaction was terminated in 3 stages: 18.329 g of 4,4′-difluorobenzophenone were added to the reaction mixture while keeping a nitrogen purge on the reactor. After 5 minutes, 2.388 g of lithium chloride were added to the reaction mixture. 10 minutes later, another 6.110 g of 4,4′-difluorobenzophenone were added to the reactor and the reaction mixture was kept at temperature for 15 minutes.

The reactor content was then poured from the reactor into a SS pan and cooled.

The solid was broken up and ground in an attrition mill through a 2 mm screen. Diphenyl sulfone and salts were extracted from the mixture with acetone and water.

The powder was then dried at 120° C. under vacuum for 12 hours yielding 191 g of a white powder.

The repeat unit of the polymer is:

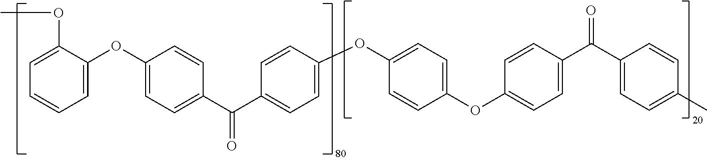

The melt viscosity measured by capillary rheology at 400° C., 1000 s−1 was 0.37 kN-s/m2.

The blend PEEK/PEEK-PEoEK (formulation 3 in Table 1) was prepared by first tumbling the polymers to be compounded, in resinous form, for about 20 minutes. Then, the formulation was melt compounded using a 26 mm diameter Coperion® ZSK-26 co-rotating partially intermeshing twin screw extruder having an L/D ratio of 48:1. The barrel sections 2 through 12 and the die were heated to set point temperatures as follows: Barrels 2-12: 350° C., Die: 350° C. The resin blend was fed at barrel section 1 using a gravimetric feeder at throughput rates in the range 30-40 lb/hr. The extruder was operated at screw speeds of around 200 RPM. Vacuum was applied at barrel zone 10 with a vacuum level of about 27 inches of mercury. A single-hole die was used for all the compounds to give a filament approximately 2.4 to 2.5 mm in diameter and the polymer filament exiting the die was cooled in water and fed to the pelletizer to generate pellets approximately 2.0 mm in length. Pellets were annealed prior to filament extrusion, as follows: 2 h @ 200° C.

### Preparation of Filaments

Feed stocks for filament production consisted of either neat polymer (PEEK or PEEK-PEoEK) or dry blends of polymeric resin. The polymers to be extruded into filament, in resinous form, were tumbled, for about 20 minutes. Filament of diameter 1.80 mm was prepared for each composition using a Brabender® Intern-Torque Plasti-Corder® Torque Rheometer extruder equipped with a 0.75″ (1.905 cm) 32 L/D general purpose single screw, a heated capillary die attachment, a 3/32″ diameter nozzle with land of length 1.5″, and downstream, custom-designed filament conveying apparatus. Other downstream equipment included a belt puller and a Dual Station Coiler, both manufactured by ESI-Extrusion Services. A Beta LaserMike® 5012 with DataPro 1000 data controller was used to monitor filament dimensions. The melt strand was cooled with air. The Brabender® zone set point temperatures were as follows: zone 1, 395° C.; zone 2 and zone 3, 400° C.; die, 340° C. The Brabender® speed ranged from 35 to 45 rpm and the puller speed from 33 to 36 feet per minute (10.058 to 10.973 meters per minute).

3D Printing

Filaments described above were printed on an F900 extrusion-based additive manufacturing system commercially available from Stratasys, Inc., Eden Prairie, Minnesota, USA. Filaments described above were printed as the model material, while Stratasys SUP8000B breakaway support material served as the support material. High-temp (PPSU) build sheets were employed as the printed object substrate. During the printing trials, model extruder temperature was set between 400-420° C., the support extruder temperature was set to around 400° C., and the heated chamber was set at 155° C. A Stratasys T20D tip was used for the model material, with a 0.013″ layer thickness, and a Stratasys T16 tip for the support material. Model material was extruded as a series of roads in a layer-by-layer fashion to print structures in the heated chamber. A 6″×6″×2 mm plaque was printed for each formulation, using 100% infill and 45°/−45° alternating rasters, and objects were promptly removed from the heated chamber and build sheet after printing.

Test Methods

DSC (Tg, Tc, Heat of fusion)

Tg is determined on the 2^{nd} heat scan in differential scanning calorimeter (DSC) according to ASTM D3418, using a heating and cooling rate of 20° C./min.

Tc is determined on the 1^{st} cool scan in differential scanning calorimeter (DSC) according to ASTM D3418, using a heating and cooling rate of 20° C./min.

Heat of fusion is determined on the 2^{nd} heat scan in differential scanning calorimeter (DSC) according to ASTM D3418, using a heating rate of 20° C./min.

Results

Table 1 provides an overview of the compositions of the filaments used in examples 1, 2, and 3.

TABLE 1

| | 1 | 2 | 3 |
|---|---|---|---|
| C: comparative | C | I | I |
| I: according to the disclosure | | | |
| PEEK-PEoEK | — | 100 | 50 |
| PEEK | 100 | — | 50 |

Table 2 provides the 1^{st} cool and 2^{nd} heat DSC data for formulations 1, 2, and 3. The last column in Table 2 displays a (Tm-Tc)/(Tm-Tg) parameter, which is a way to compare crystallization speed between similar types of polymers (i.e. PAEKs in this case) with different glass and melting transition temperatures. The closer this number is to 0.0, the closer Tc is to Tm and the faster the crystallization speed; the closer this number is to 1.0, the closer Tc is to Tg and the slower the crystallization speed. This ratio effectively measures the supercoiling thermal driving force required to effect crystallization.

TABLE 2

| | | DSC 1st | | | | | | | |
|---|---|---|---|---|---|---|---|---|---|
| | | cool scan | | DSC 2nd heat scan | | | | | |
| | Compo- | Tc | ΔHc | Tg | Tc | ΔHc | Tm | ΔHm | (Tm-Tc)/ |
| | sition | (° C.) | (J/g) | (° C.) | (° C.) | (J/g) | (° C.) | (J/g) | (Tm-Tg) |
| 1 | PEEK | 290 | 54 | 151 | — | — | 341 | 52 | 0.27 |
| 2 | PEEK- | 233 | 35 | 147 | — | — | 303 | 41 | 0.45 |
| | PEoEK | | | | | | | | |
| 3 | 50/50 | 272 | 49 | 148 | — | — | 333 | 55 | 0.33 |
| | blend | | | | | | | | |

PEEK possesses the highest relative crystallization speed at 0.27, while PEEK-PEoEK is the slowest at 0.45 and the 50/50 blend splits the difference at 0.33. In the enthalpy of melting column (ΔHm), the PEEK-PEoEK copolymer also possesses a lower absolute degree of crystallinity than PEEK at 41 J/g vs 52 J/g respectively, while the 50/50 blend possesses a similar degree of crystallinity to the neat PEEK at 55 vs 52 J/g).

The melting point of both the neat PEEK-PEoEK copolymer (303° C.) and a 50/50 blend of the same with PEEK (333° C.) is also advantageously lower than neat PEEK (343° C.), which provides for more facile melt processing and also a lower chance for thermal degradation as compared to neat PEEK, as all of these polymer possess similar degradation temperatures that arise from fundamentally the same ether and ketone bonds and their resulting bond dissociation energies.

6″×6″×2 mm plaques were printed using the above materials. For the PEEK material, there was some undesirable warpage in the front left corner of the object, which curled upward during the printing process. The central defect in all three printed objects is a clipping used for DSC analysis of the printed part, described further below. The PEEK-PEoEK copolymer did not warp during the 3D printing process. After removal from the PPSU build sheet, it displayed a slight downward curvature. The 3D printed plaque from the 50/50 blend material advantageously lied flat both during the 3D printing process and also after removal from the PPSU build sheet, without displaying any curling or warpage.

Table 3 provides 1^{st} heat DSC thermal transitions for clippings from the 3D printed object. The heated chamber is held at 155° C. which is very close to T g for all of these polymers.

TABLE 3

DSC 1st heat scan

| | | Tc | ΔHc | Tm | ΔHm |
|---|---|---|---|---|---|
| | Composition | (° C.) | (J/g) | (° C.) | (J/g) |
| 1 - printed | PEEK | — | — | 341 | 45 |
| 2 - printed | PEEK-PEoEK | 201 | 27 | 305 | 33 |
| 3 - printed | 50/50 blend | 185 | 15 | 337 | 41 |

The PEEK printed part is fully crystallized during the printing process, as indicated by the absence of a cold crystallization peak during the DSC 1^{st} heat scan. The neat PEEK-PEoEK copolymer possesses a cold crystallization enthalpy (ΔH_{c}) of 27 J/g, whereas the 50/50 blend possesses a lower ΔH_{c} of 15 J/g, indicating that more of the 50/50 blend crystallized during the printing process as compared to the PEEK-PEoEK copolymer.

All the above results taken together, it is apparent that PEEK-PEoEK and a blend of the same with PEEK advantageously possesses both a lower degree of crystallinity and a slower crystallization speed than PEEK, while retaining crystallinity from the 3D printing process. Although PEEK-PEoEK and a blend of the same with PEEK partly crystallized during the 3D printing process, they surprisingly and advantageously did not warp while printing. This is contrasted with neat PEEK, which warped during the 3D printing process. This retained crystallinity of PEEK-PEoEK and its blends with PEEK is advantageous for thermal, mechanical, and chemical resistance properties of the printed part, as well as maintaining part shape should the end user decide to perform a post-printing annealing step to further increase part crystallinity.

1. An additive manufacturing (AM) method for making a three-dimensional (3D) object, comprising extruding a part material (M) comprising a polymer component, such polymer component comprising at least one PEEK-PEoEK copolymer, wherein the copolymer comprises at least 50 mol. %, collectively, of repeat units (R_{PEEK}) and repeat units (R_{PEoEK}), relative to the total number of repeat units in the PEEK-PEoEK copolymer, wherein:
(a) repeat units (R_{PEEK}) are repeat units of formula (A): 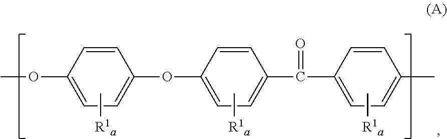
and
(b) repeat units (R_{PEoEK}) are repeat units of formula (B): 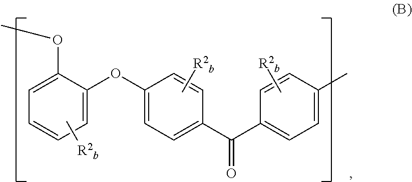
wherein
each R¹ and R², equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

2. The method of claim 1, wherein the repeat units (R_{PEEK}) are repeat units of formula:

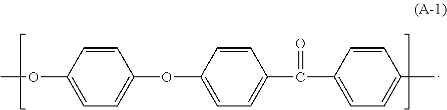

3. The method of claim 1, wherein the repeat units (R_{PEoEK}) are repeat units of formula:

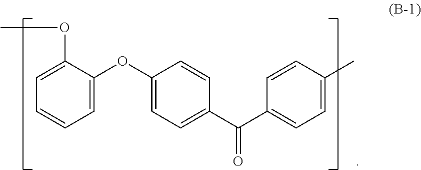

4. The method of claim 1, wherein the PEEK-PEoEK copolymer is essentially composed of repeat units (R_{PEEK}) and (R_{PEoEK}), wherein any additional repeat unit different from repeat units R_{PEEK} and R_{PEoEK}, are either absent or may be present in amount of at most 2 mol. % relative to the total number of moles of repeat units in the PEEK-PEoEK copolymer.

5. The method of claim 1, wherein repeat units R_{PEEK} and R_{PEoEK} are present in the PEEK-PEoEK copolymer in a R_{PEEK}/R_{PEoEK} molar ratio ranging from 95/5 to more than 50/50.

6. The method of claim 1, wherein the part material (M) further comprises 0.1 wt. % to 60 wt. %, with respect to the total weight of the part material, of an additive selected from the group consisting of flow agents, fillers, colorants, lubricants, plasticizers, stabilizers, flame retardants, nucleating agents and combinations thereof.

7. The method of claim 1, wherein the polymer component of the part material (M) further comprises at least one polymer distinct from the PEEK-PEoEK copolymer.

8. The method of claim 1, wherein the part material (M) is the shape of a filament having a cylindrical or ribbon-like geometry, its diameter or at least one its section having a size varying between 0.5 mm and 5 mm.

9. The method of claim 1, wherein the part material (M) is the form of pellets having a size ranging from 1 mm to 1 cm.

10. The method of claim 1, wherein the part material (M) comprises a polymer component comprising:
from 20 to 99 wt. % of at least one PEEK-PEoEK copolymer, and
from 1 to 80 wt. % of at least one PEEK (co)polymer, based on the total weight of the polymer component.

11. A filament material having a cylindrical geometry and a diameter comprised between 0.5 and 5 mm±0.15 mm, comprising a polymer component, such polymer component comprising at least one PEEK-PEoEK copolymer, wherein the copolymer comprises at least 50 mol. %, collectively, of repeat units (R_{PEEK}) and repeat units (R_{PEoEK}), relative to the total number of repeat units in the PEEK-PEoEK copolymer, wherein:
(a) repeat units (R_{PEEK}) are repeat units of formula (A): 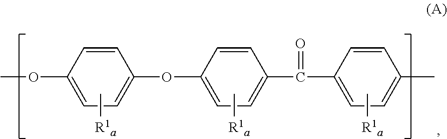
and
(b) repeat units (R_{PEoEK}) are repeat units of formula (B): 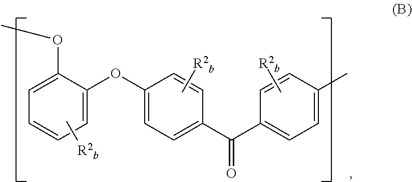
wherein
each R¹ and R², equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

12. The filament material of claim 11, wherein the filament is obtained by a melt-mixing process carried out by heating the polymer component above its melting temperature and melt-mixing the components of the part material.

13. The filament material of claim 11, wherein the polymer component comprises at least 80 wt. % of the PEEK-PEoEK copolymer, based on the total weight of polymeric component of the filament.

14. A three-dimensional (3D) object obtained by an extrusion-based 3D printing process, from a part material (M) comprising a polymer component, such polymer component comprising at least one PEEK-PEoEK copolymer, wherein the copolymer comprises at least 50 mol. %, collectively, of repeat units (R_{PEEK}) and repeat units (R_{PEoEK}), relative to the total number of repeat units in the PEEK-PEoEK copolymer, wherein:
(a) repeat units (R PEEK) are repeat units of formula (A): 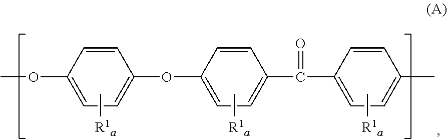
and
(b) repeat units (R_{PEoEK}) are repeat units of formula (B): 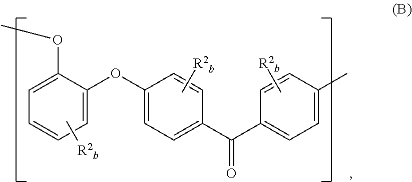
wherein
each R¹ and R², equal to or different from each other, is independently at each occurrence selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium,
each a and b is independently selected from the group consisting of integers ranging from 0 to 4, and
the PEEK-PEoEK copolymer comprises the repeat units R_{PEEK} and R_{PEoEK} in a molar ratio R_{PEEK}/R_{PEoEK} ranging from 95/5 to 5/95.

15. (canceled)
